(19) United States
(12) Patent Application Publication
(10) Pub. No.: US 2017/0325101 A1
(43) Pub. Date: Nov. 9, 2017

(54) METHOD AND APPARATUS FOR REAL-TIME SELF-MONITORING OF MULTI-CARRIER TRANSMISSION QUALITY

(71) Applicant: QUALCOMM Incorporated, San Diego, CA (US)

(72) Inventors: Joseph Gates, San Diego, CA (US); Li Gao, San Diego, CA (US); Narendra Gottimukkala, San Diego, CA (US); Douglas Grover, San Diego, CA (US); Insung Kang, San Diego, CA (US); Dongbo Zhang, San Diego, CA (US)

(21) Appl. No.: 15/148,629

(22) Filed: May 6, 2016

(51) Int. Cl. H04W 24/02; H04B 1/00; H04L 25/03; H04W 24/06

(52) U.S. Cl. CPC H04W 24/02; H04W 24/06; H04B 1/0007; H04L 25/03019

(57) ABSTRACT

Embodiments described herein provide a method and apparatus for monitoring and correcting a transmit signal. A first sample is taken before the signal is input to a digital to analog converter (DAC) in a transmit chain. A second sample is taken of the transmit signal after the signal has passed through the power amplifier (PA). The first and second transmit samples are then compared and an equalizer interpolation value is determined. This equalizer interpolation value is applied to the transmit signal before transmission to provide a transmit signal with improved quality. The apparatus includes a feedback receive correction unit; a time domain processor in communication with the feedback receive correction unit; a frequency domain processing equalizer in communication with the time domain processor; an equalizer interpolation unit; an absolute value squaring unit in communication with the equalizer interpolation unit; and a processor for computation of a transmit quality parameter.

### FIELD

The present disclosure relates generally to wireless communication systems, and more particularly to a method and apparatus for real-time self-monitoring of multi-carrier transmission quality.

### BACKGROUND

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipment, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

Transmit quality metrics such as error vector magnitude (EVM), spectral flatness, adjacent channel leakage ratio (ACLR), are used to determine the quality of the radio transmitter used in digital communications. Noise, distortion, filter response, spurious signals, phase noise, residual sideband (RSB) may all degrade transmit quality. Minimum requirements for these metrics may be provided by standards. Radio transmitters undergo testing for carrier compliance with the applicable standards for band used by the transmitters. This testing of quality metrics in the factory may take considerable time and may require the radio transmitter to be connected to costly test equipment. This testing may be required for each transmit band and frequency where the radio transmitter may operate. Each frequency band may require separate testing using the connected test equipment.

There is a need in the art for an equipment-free measurement of transmit quality metrics for multi-carrier transmission and for an on-line transmit quality monitor to further optimize the transmitter for improved performance.

### SUMMARY

Embodiments described herein provide a method for monitoring and correcting a transmit signal. The method begins with sampling at least one transmit signal in a transmit chain. This first sample is taken before the signal is input to a digital to analog converter (DAC). A second sample is taken of the transmit signal after the signal has passed through the power amplifier (PA). The first and second transmit samples are then compared and an equalizer interpolation value is determined. This equalizer interpolation value is then applied to the transmit signal before transmission to provide a transmit signal with improved quality. The method may also be used to monitor transmit signals on an ongoing basis and to provide transmit signal quality correction.

A further embodiment provides an apparatus for monitoring and correcting a transmit signal. The apparatus includes a feedback receive correction unit; a time domain processor in communication with the feedback receive correction unit; a frequency domain processing equalizer in communication with the time domain processor; an equalizer interpolation unit; an absolute value squaring unit in communication with the equalizer interpolation unit; and a processor for computation of a transmit quality parameter.

A still further embodiment provides an apparatus for monitoring and correcting a transmit signal. The apparatus includes: means for sampling at least one transmit signal before a digital to analog converter (DAC) to obtain a first transmit signal sample; means for sampling a transmit signal after a power amplifier (PA) to obtain a second transmit signal sample; means for comparing the first transmit signal sample and the second transmit signal sample; means for determining an equalizer interpolation value; and means for applying the equalizer interpolation value to the transmit signal before transmission.

A yet further embodiment provides a non-transitory computer-readable medium containing instructions, which when executed, cause a processor to perform the following steps: sampling at least one transmit signal before a DAC to obtain a first transmit signal sample; sampling a transmit signal after a PA to obtain a second transmit signal sample; comparing the first transmit signal sample and the second transmit signal sample; determining an equalizer interpolation value; and applying the equalizer interpolation value to the transmit signal before transmission.

### BRIEF DESCRIPTION OF THE DRAWINGS

FIG. 1 illustrates a wireless multiple-access communication system, in accordance with certain embodiments of the disclosure.

FIG. 2 is a block diagram of a wireless communication system in accordance with embodiments of the disclosure.

FIG. 3 is a block diagram of an apparatus for equipment-free testing and on-line transmit quality monitoring of a radio transmitter, in accordance with certain embodiments of the disclosure.

FIG. 4 is a block diagram of an apparatus for frequency domain processing and equalizer construction with real-time optimization, in accordance with certain embodiments of the disclosure.

FIG. 5 illustrates a reference multi-carrier transmission and a feedback receiver distorted multi-carrier transmission, in accordance with certain embodiments of the disclosure.

FIG. 6 is a flowchart of a method for real-time self-monitoring of multi-carrier transmission quality, in accordance with certain embodiments of the disclosure.

### DETAILED DESCRIPTION

The detailed description set forth below in connection with the appended drawings is intended as a description of exemplary embodiments of the present disclosure and is not intended to represent the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the present disclosure. It will be apparent to those skilled in the art that the exemplary embodiments of the present disclosure may be practiced without these specific details. In some instances, well-known structures and devices are shown in block diagram form in order to avoid obscuring the novelty of the exemplary embodiments presented herein.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, an integrated circuit, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network, such as the Internet, with other systems by way of the signal).

Furthermore, various aspects are described herein in connection with an access terminal and/or an access point. An access terminal may refer to a device providing voice and/or data connectivity to a user. An access wireless terminal may be connected to a computing device such as a laptop computer or desktop computer, or it may be a self-contained device such as a cellular telephone. An access terminal can also be called a system, a subscriber unit, a subscriber station, mobile station, mobile, remote station, remote terminal, a wireless access point, wireless terminal, user terminal, user agent, user device, or user equipment. A wireless terminal may be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. An access point, otherwise referred to as a base station or base station controller (BSC), may refer to a device in an access network that communicates over the air-interface, through one or more sectors, with wireless terminals. The access point may act as a router between the wireless terminal and the rest of the access network, which may include an Internet Protocol (IP) network, by converting received air-interface frames to IP packets. The access point also coordinates management of attributes for the air interface.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ), and integrated circuits such as read-only memories, programmable read-only memories, and electrically erasable programmable read-only memories.

Various aspects will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Other aspects, as well as features and advantages of various aspects, of the present disclosure will become apparent to those of skill in the art through consideration of the ensuring description, the accompanying drawings and the appended claims.

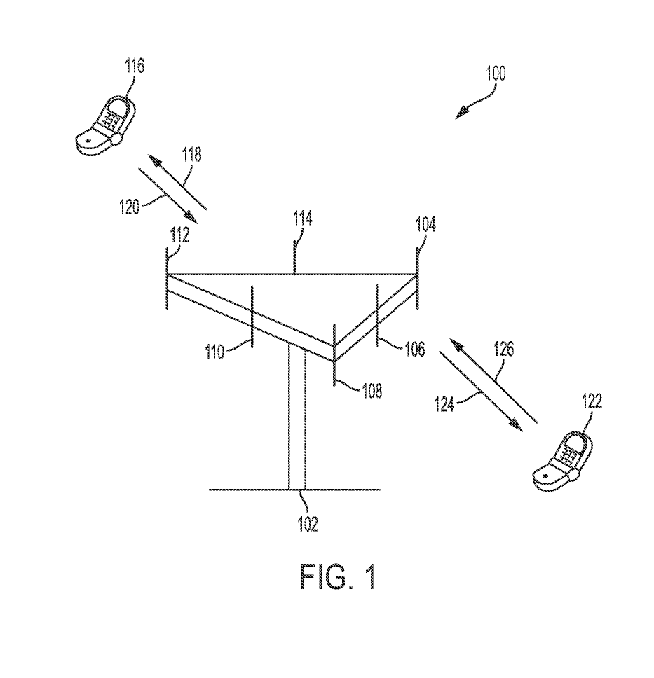

FIG. 1 illustrates a multiple access wireless communication system 100 according to one aspect. An access point 102 (AP) includes multiple antenna groups, one including 104 and 106, another including 108 and 110, and an additional one including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink or forward link 118 and receive information from access terminal 116 over uplink or reverse link 120. Access terminal 122 is in communication with antennas 106 and 108, where antennas 106 and 108 transmit information to access terminal 122 over downlink or forward link 124, and receive information from access terminal 122 over uplink or reverse link 126. In a frequency division duplex (FDD) system, communication link 118, 120, 124, and 126 may use a different frequency for communication. For example, downlink or forward link 118 may use a different frequency than that used by uplink or reverse link 120.

Each group of antennas and/or the area in which they are designed to communicate is often referred to as a sector of the access point. In an aspect, antenna groups are each designed to communicate to access terminals in a sector of the areas covered by access point 102.

In communication over downlinks or forward links 118 and 124, the transmitting antennas of an access point utilize beamforming in order to improve the signal-to-noise ratio (SNR) of downlinks or forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal or some other terminology. For certain aspects, either the AP 102, or the access terminals 116, 122 may utilize the techniques described below to improve performance of the system.

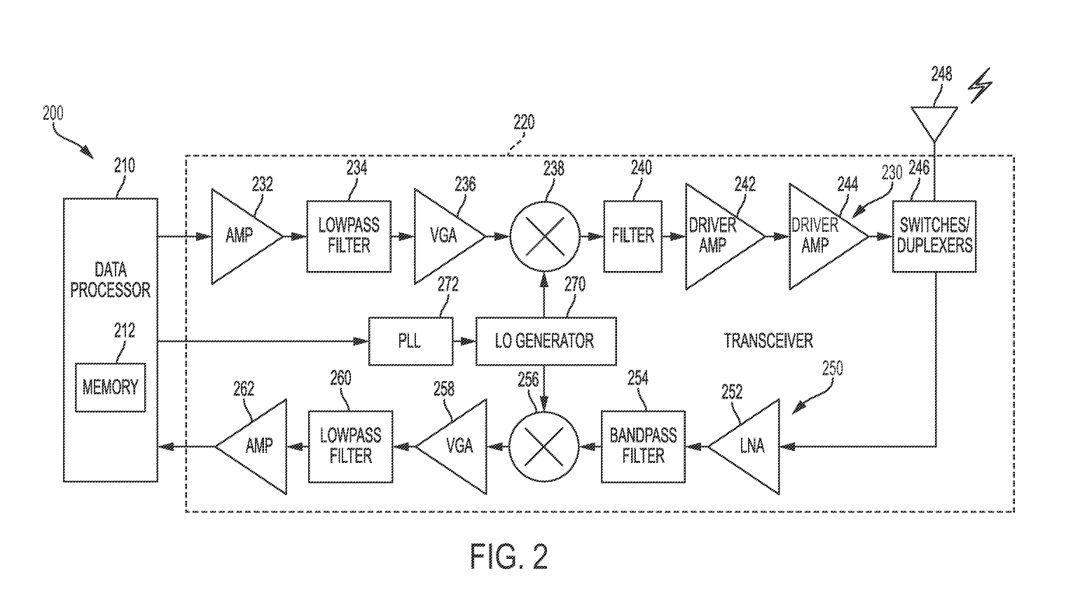

FIG. 2 shows a block diagram of an exemplary design of a wireless communication device 200. In this exemplary design, wireless device 200 includes a data processor 210 and a transceiver 220. Transceiver 220 includes a transmitter 230 and a receiver 250 that support bi-directional wireless communication. In general, wireless device 200 may include any number of transmitters and any number of receivers for any number of communication systems and any number of frequency bands.

In the transmit path, data processor 210 processes data to be transmitted and provides an analog output signal to transmitter 230. Within transmitter 230, the analog output signal is amplified by an amplifier (Amp) 232, filtered by a low pass filter 234 to remove images caused by digital-to-analog conversion, amplified by a variable gain amplifier (VGA) 236, and upconverted from baseband to RF by a mixer 238. The upconverted signal is filtered by a filter 240, further amplified by a driver amplifier, 242 and a power amplifier 244, routed through switches/duplexers 246, and transmitted via an antenna 249.

In the receive path, antenna 248 receives signals from base stations and/or other transmitter stations and provides a received signal, which is routed through switches/duplexers 246 and provided to receiver 250. Within receiver 250, the received signal is amplified by an LNA 252, filtered by a bandpass filter 254, and downconverted from RF to baseband by a mixer 256. The downconverted signal is amplified by a VGA 258, filtered by a low pass filter 260, and amplified by an amplifier 262 to obtain an analog input signal, which is provided to data processor 210.

FIG. 2 shows transmitter 230 and receiver 250 implementing a direct-conversion architecture, which frequency converts a signal between RF and baseband in one stage. Transmitter 230 and/or receiver 250 may also implement a super-heterodyne architecture, which frequency converts a signal between RF and baseband in multiple stages. A local oscillator (LO) generator 270 generates and provides transmit and receive LO signals to mixers 238 and 256, respectively. A phase locked loop (PLL) 272 receives control information from data processor 210 and provides control signals to LO generator 270 to generate the transmit and receive LO signals at the proper frequencies.

FIG. 2 shows an exemplary transceiver design. In general, the conditioning of the signals in transmitter 230 and receiver 250 may be performed by one or more stages of amplifier, filter, mixer, etc. These circuits may be arranged differently from the configuration shown in FIG. 2. Some circuits in FIG. 2 may also be omitted. All or a portion of transceiver 220 may be implemented on one or more analog integrated circuits (ICs), RF ICs (RFICs), mixed-signal ICs, etc. For example, amplifier 232 through power amplifier 244 in transmitter 230 may also be implemented on an RFIC. Driver amplifier 242 and power amplifier 244 may also be implemented on another IC external to the RFIC.

Data processor 210 may perform various functions for wireless device 200, e.g., processing for transmitter and received data. Memory 212 may store program codes and data for data processor 210. Data processor 210 may be implemented on one or more application specific integrated circuits (ASICs) and/or other ICs.

The radio transmitter described in FIG. 2 is tested to determine how well it transmits and receives. The testing may be used to determine transmit quality metrics including error vector magnitude (EVM), spectral flatness, and ACLR, which may indicate the quality of the transmitter. Noise distortion filter response, spurious signals, phase noise, RSB, may degrade transmit quality and may not meet the minimum requirements for the standard and the operating frequency bands.

Testing is used to determine if the radio transmitter meets the operating requirements of the standard and may require the radio transmitter to be connected to specialized testing equipment. These tests may be time consuming and expensive to perform, as the test equipment may need to be rented and calibrated. In addition, for multi-carrier radio transmitters, multiple frequency bands may need to be tested. These factors may increase the amount of time required for the testing. Test time may be increased as the number of aggregated carriers per transmitter increases.

Embodiments described herein provide a method for measuring transmit quality metrics without using specialized test equipment. The embodiments are suitable for multi-carrier transmission. Transmit quality measurements may be provided through the capture and equalization of multi-carrier transmissions for reporting or real-time correction. In addition, additional embodiments provide the capability for an on-line transmit quality monitor that may further optimize the transmitter for improved performance through the use on real-time measurements. This real-time measuring may provide an ongoing mechanism for further optimization of the transmitter for improved performance.

An advantage of the method and apparatus described herein is the reduction of factory and on-line measurement time for multi-carrier transmissions. The measurement requires no external equipment to the radio transmitter, and measurements may be made in the field or the factory. Measurements made in the field may use an on-line method for measuring transmission quality in real-time. EVM and spectral flatness measurements may be made per-carrier without incurring additional processing time. When testing in the field using the on-line process, real-time corrections may be applied per carrier based on the transmit quality measurements. Embodiments described herein use a feedback chain to capture a transmit signal. This capture is made before the transmit signal reaches the DAC and used a combined carrier signal as a reference. The embodiments allow for the measurement of any number of carrier aggregations and/or resource block allocations in a single sample capture. An advantage of the embodiments described herein is that demodulation of the signal is not required and the method remains accurate with a small number of samples. The real-time knowledge of the transmit quality metrics allows for dynamic adjustment of the transmitter parameters to provide better transmit performance.

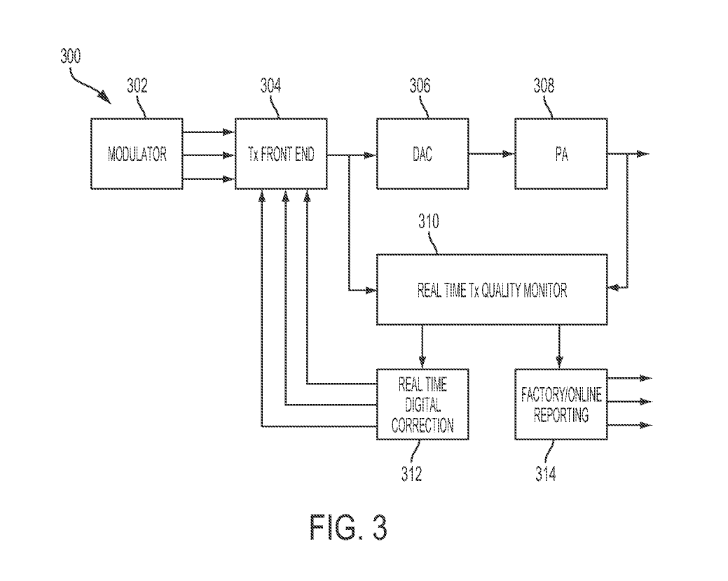

FIG. 3 is a block diagram of an apparatus for the capture and equalization of multicarrier transmissions for transmit quality measurement for reporting or for real-time correction of transmit quality. The apparatus 300 includes a modulator 302 that is in communication with transmit (Tx) front end 304. The Tx front end 304 provides input signals to digital-to-analog converter (DAC) 306. DAC 306 provides input to power amplifier (PA) 308 and real time transmit (Tx) quality monitor 310. PA 308 also provides input to real time Tx quality monitor 310. In addition, PA 308 may provide the transmit output signal. The real time Tx quality monitor 310 provides output to real time digital correction unit 312 and also to factory/online reporting unit 314. Real time digital correction unit 312 provides correction signal input to Tx front end 304. Factory/online reporting unit 314 may provide additional output signals that may be determined based on the specific functions to be reported.

In operation real-time quality monitor 310 receives input from the Tx front end 304, before the signal is input to DAC 306. At this point, the Tx signal has not been processed by the DAC 306 or the PA 308, and the signal may be comparatively clean. The real-time quality monitor 310 also receives output from PA 308. The signal output by PA 308 may have distortion, noise, or other degradations. By comparing the signal input to the real-time quality monitor 310 before the DAC 306 and PA 308 with the signal input to the real-time quality monitor 310 after processing by DAC 306 and PA 308 the amount of distortion, noise, or other degradation can be determined.

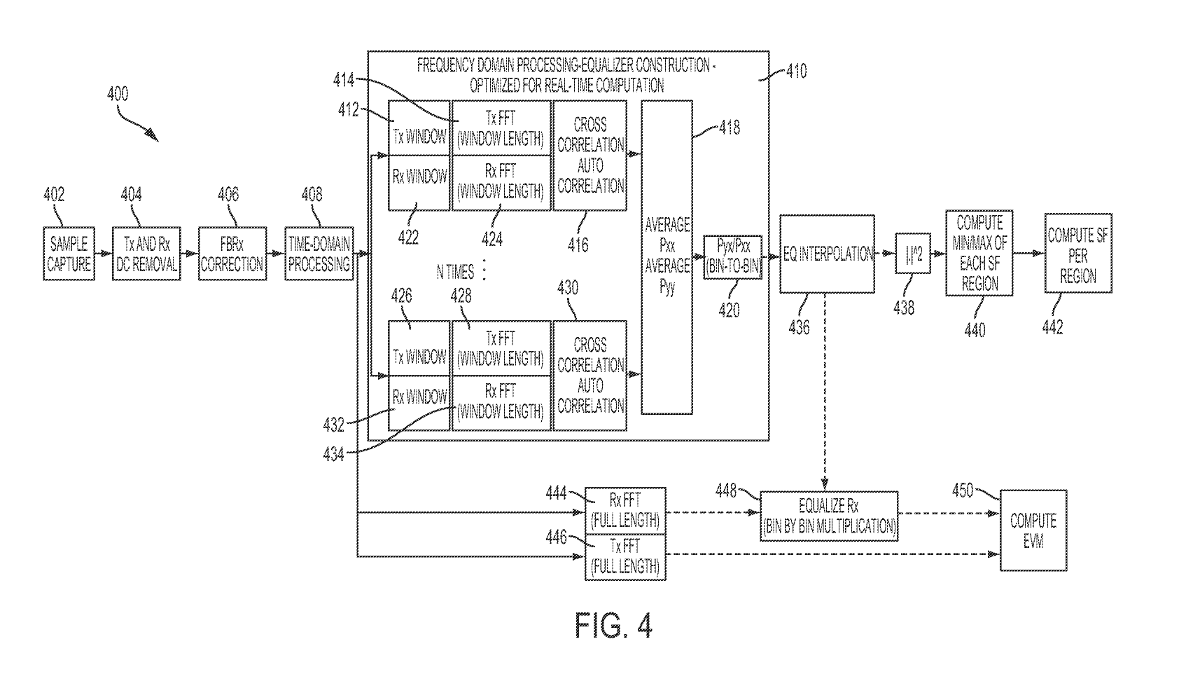

FIG. 4 provides a transmit quality calculation signal processing flow. The signal processing flow 400 begins with sample capture at block 402. Once the sample has been captured, the transmit (Tx) and receive (Rx) direct current (DC) is removed at block 404. The signal is then passed to feedback correction block 406. The feedback correction output then undergoes time domain processing in block 408. The output from the time domain processing of block 408 is then input to the frequency domain processing equalizer construction unit 410. The output of the time domain processing in block 408 is also sent to a receive Fast Fourier Transform (Rx FFT) unit 444 and a transmit Fast Fourier Transform unit (Tx FFT) 446. The frequency domain processing equalizer 410 is optimized for real time computation.

The signal from time domain processing block 408 is split into multiple windows, which is indicated in FIG. 4 as “N Times”. Each signal stream has Tx windows, indicated as blocks 412 and 426. Similarly, each signal stream has Rx windows, indicated as blocks 422 and 432. The windows may represent a sample of the signal and may not include a full frame of signal data. This division into multiple windows in the time domain allows measurement of any number of sample segments for FFT analysis. Carrier aggregation is done by measurement of EVM n the frequency domain where compute EVM block 450 is operated over bin segments representing each carrier. and/or resource block allocations within a single sample capture. The Tx windows 412 and 426 and Rx windows 422 and 432 pass data through a Fast Fourier Transform (FFT) analysis in blocks 414 and 428 for the Tx FFT and blocks 424 and 434 for the Rx FFT. The Tx FFT units 414 and 428 as well as the Rx FFT units 424 and 434 take the input from DAC 306 and PA 308. This input is inserted into the FFT units where it is iterated N times. Fourier analysis may be used to convert a signal from an original time domain to a representation in the frequency domain.

The outputs from the FFT blocks 414, 424, 428, and 434 are input to cross-correlation/auto-correlation blocks. Tx FFT block 414 inputs to cross-correlation/auto-correlation block 416, while Tx FFT 428 and Rx FFT 424 input to cross-correlation/auto-correlation block 430. Cross-correlation is a measure of the similarity of two signals as a function of the lag of one signal with respect to the other signal. Autocorrelation is the cross correlation of a signal with itself. Autocorrelation peaks when there is a lag of zero. Both cross-correlation/auto-correlation blocks input to an averaging Pxx and Pyy unit 418, where the cross-correlation inputs from cross-correlation/auto-correlation blocks are averaged.

The average Pxx average Pyy unit 418 inputs to the Pyx/Pxx (bin-by-bin) unit 420. Average Pxx Pyy unit 418 may perform the averaging. This averaging may be done N times. Pyx/Pxx unit 420 record the bin data in a bin-by-bin manner. At this point, the frequency domain processing unit 410 has completed operation and the equalizer interpolation begins. The frequency domain processing equalizer 410 looks for the error generated by the DAC 306 and PA 308 and examines the droop in the PA transmit signal to determine what noise, RSB, or ACLR may be degrading the signal.

Equalizer interpolation (EQ interpolation) unit 436 interpolates the results received from the frequency domain equalizer unit 410. This results in an equalized (EQ) interpolation that is output from EQ interpolation unit 436 outputs the results to block 438 and applies the equalizer to the Rx samples in block 448. In block 438 the EQ interpolation measures spectral flatness as the difference in the minimum/maximum of the EVM equalizer. The result is then passed to computation block 442 where a SF is computed for each region. The output of the EQ interpolation unit 436 is also passed to block 448, where bin-by-bin multiplication occurs.

The output from the Rx FFT 444 is input to the Equalize Rx block 448. This output from the Rx FFT 444 is a full capture frame length, in contrast to the window length or sample length discussed above. The embodiments described herein may be used with a full capture length frame, in contrast to a standard specified full frame of data. The Equalize Rx block 448 performs bin by bin multiplication of the Rx FFT data for a full frame length. The output from Equalize Rx block 448 is input to the error vector magnitude computation unit (EVM) unit 450. The EVM computation unit 450 also receives input from the Tx FFT unit 446. This processing flow allows a software algorithm to process reference and transmit waveforms to calculate transmit quality metrics internally per carrier. The transmit quality metrics computed include EVM, spectral flatness, and ACLR internally per carrier.

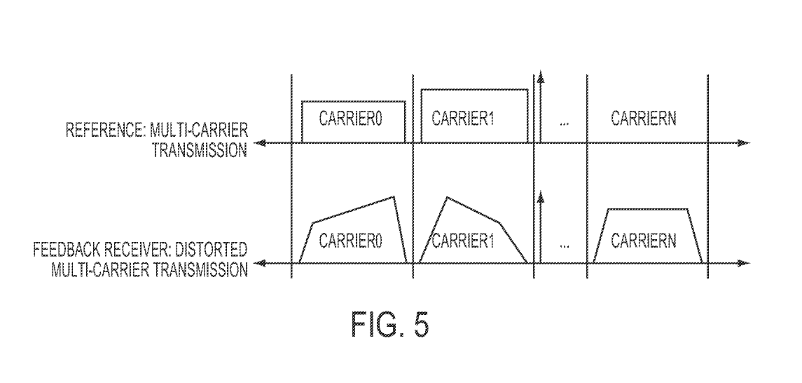

FIG. 5 depicts a reference multi-carrier transmission and a feedback receiver distorted multi-carrier transmission. The reference multicarrier transmission shows a flat signal across the frequency domain, which depicts an idea signal. The feedback receiver distorted multi-carrier transmission shown below, represents an actual signal that may include signal noise, ACLR, and other unwanted signal components. The EVM and spectral flatness of the feedback receiver distorted multi-carrier signal measurements may be made using the embodiments described above. The DAC 306 and PA 308 may suffer performance degradation over time, with the resulting signals showing losses. Using the embodiments described herein the multi-carrier transmissions may be corrected as shown at the right of the multi-carrier signal. The smooth signal envelope shows that online real-time correction can be applied based on the Tx quality measurements and may result in an improved Tx signal. The online real-time correction may be applied per carrier on an ongoing basis and may eliminate the need for testing and adjusting the device. The Tx quality metrics may be reported on all technologies for a multi-mode self-measuring device.

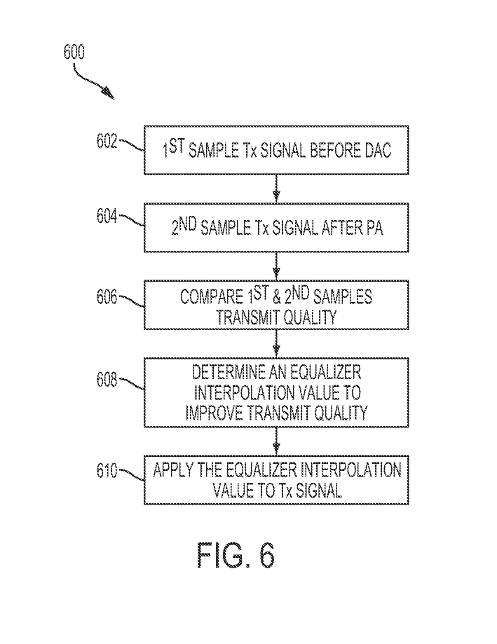

FIG. 6 is a flowchart of a method for real-time self-monitoring of multi-carrier transmission quality. The method 600 begins when a first sample of a Tx signal is taken before DAC, in block 602. The sample is taken in the transmit chain before the DAC because the DAC may introduce noise or other harmful components onto the signal. Taking the sample before the DAC provides a view of the signal with no noise or added components. A second sample of the Tx signal is taken after the PA in block 604. The PA is another component that may introduce noise or harmful components onto the signal. The first and second samples of the Tx signal are compared in block 606. The comparison indicates what noise, ACLR, RSB, of other harmful components have been added by the DAC and PA. Once the comparison is made, then in block 608 an equalizer interpolation value is determined, based on the comparison. The equalizer interpolation value is used to improve that signal quality in block 610 when the equalizer interpolation value is applied to the transmit signal.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitter over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM EEPROM, CD-ROM or other optical disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A method of monitoring and correcting a transmit signal, comprising:
sampling at least one transmit signal before a digital to analog converter (DAC) to obtain a first transmit signal sample;
sampling a transmit signal after a power amplifier (PA) to obtain a second transmit signal sample;
comparing the first transmit signal sample and the second transmit signal sample;
determining an equalizer interpolation value; and
applying the equalizer interpolation value to the transmit signal before transmission.

2. The method of claim 1, wherein the transmit signal is a multi-carrier transmit signal.

3. The method of claim 1, wherein a time domain signal is inserted into the first and second transmit signal samples to produce first and second time domain first and second transmit signal samples.

4. The method of claim 3, wherein the first and second time domain first and second signal samples are input to a Fourier transform unit.

5. The method of claim 4, further comprising: sampling a transmit signal before a DAC to obtain a predetermined number of samples; and sampling a transmit signal after PA to obtain a predetermined number of samples.

6. The method of claim 5, further comprising: cross-correlating and auto-correlating Fourier transform values for the first and second transmit signal samples.

7. The method of claim 7, further comprising: averaging the cross-correlated and auto-correlated Fourier transform values for the first and second transmit signal samples.

8. An apparatus for monitoring and correcting a transmit signal, comprising:
a sample capture unit in communication with a transmit and receive direct current removal unit, the sample capture unit configured to capture at least one transmit signal before a digital to analog converter (DAC);
a feedback receive correction unit;
a time domain processor in communication with the feedback receive correction unit, the time domain processor configured to sample in a time domain window a second transmit signal after a power amplifier;
a frequency domain processing equalizer in communication with the time domain processor;
an equalizer interpolation unit, configured to determine an equalizer interpolation value;
an absolute value squaring unit in communication with the equalizer interpolation unit; and
a processor for computation of a transmit quality parameter.

9. The apparatus of claim 8, wherein the apparatus for monitoring and correcting a transmit signal is installed in a system-on-chip (SoC) device.

10. The apparatus of claim 8, wherein the apparatus for monitoring and correcting a transmit signal is in communication with a transmitter front end.

11. The apparatus of claim 10, wherein the transmitter front end is in communication with a modulator.

12. The apparatus of claim 8, wherein the feedback receive correction unit is in communication with a real time digital correction unit.

13. The apparatus of claim 12, wherein the real time transmit quality monitor is in communication with an online reporting device.

14. The apparatus of claim 12, wherein the real time transmit quality monitor is in communication with a factory monitoring device.

15. An apparatus for monitoring and correcting a transmit signal comprising:
means for sampling at least one transmit signal before a digital to analog converter (DAC) to obtain a first transmit signal sample;
means for sampling a transmit signal after a power amplifier (PA) to obtain a second transmit signal sample;
means for comparing the first transmit signal sample and the second transmit signal sample;
means for determining an equalizer interpolation value; and
means for applying the equalizer interpolation value to the transmit signal before transmission.

16. The apparatus of claim 15, further comprising: means for processing a Fourier transform.

17. The apparatus of claim 16, further comprising: means for cross-correlating and auto-correlating Fourier transform values for the first and second transmit signals.

18. The apparatus of claim 17, further comprising: means for averaging the cross-correlated and auto-correlated Fourier transform values for the first and second transmit signal samples.

19. A non-transitory computer-readable medium containing instructions, which when performed by a processor, cause the processor to perform the following steps:
sample at least one transmit signal before a digital to analog converter (DAC) to obtain a first transmit signal sample;
sample a transmit signal after a power amplifier (PA) to obtain a second transmit signal sample;
compare the first transmit signal sample and the second transmit signal sample;
determine an equalizer interpolation value; and
apply the equalizer interpolation value to the transmit signal before transmission.

20. The non-transitory computer-readable medium of claim 19, further comprising instructions for: inserting a time domain signal into the first and second transmit signal samples to produce first and second time domain first and second transmit signal samples.

21. The non-transitory computer-readable instructions of claim 20, further comprising instructions: for inserting the first and second time domain signal samples into a Fourier transform unit.

22. The non-transitory computer-readable instructions of claim 21, further comprising instructions for: sampling a transmit signal before a digital to analog converter (DAC) to obtain a predetermined number of samples; and instructions for sampling a transmit signal after a power amplifier (PA) to obtain a predetermined number of samples.

23. The non-transitory computer-readable medium of claim 22, further comprising instructions for: cross-correlating and auto-correlating Fourier transform values for the first and second transmit signal samples.

24. The non-transitory computer-readable medium of claim 23 further comprising instructions for: averaging the cross-correlated and auto-correlated Fourier transform values for the first and second transmit signal samples.

25. The non-transitory computer-readable medium of claim 24, further comprising instructions for online reporting of transmit quality based on a corrected transmit signal.
